(19) United States
(12) Patent Application Publication
(10) Pub. No.: US 2014/0327944 A1
(43) Pub. Date: Nov. 6, 2014

(54) HOLOGRAM PROCESSING METHOD AND SYSTEM

(71) Applicant: CSIR, Pretoria (ZA)

(72) Inventors: Thegaran Naidoo, Boksburg (ZA); Johan Hendrik Swart, Pretoria (ZA); Suzanne Hugo, Johannesburg (ZA); Pieter Van Rooyen, San Diego, CA (US)

(21) Appl. No.: 14/362,082

(22) PCT Filed: Nov. 30, 2012
(86) PCT No.: PCT/IB2012/056850

§ 371 Date: May 30, 2014

(30) Foreign Application Priority Data
Dec. 2, 2011 (ZA) 2011/08880

(51) Int. Cl. G03H 1/00; G03H 1/04; G03H 1/08

(52) U.S. Cl. CPC G03H 1/0005; G03H 1/08; G03H 1/0443; G03H 2001/0038; G03H 2001/005; G03H 2001/0452
USPC 359/9; 359/1

(57) ABSTRACT

The invention relates to a hologram, or holographic intensity data, processing method and system. The system implements the method which comprises receiving holographic intensity data comprising at least a holographic intensity pattern or image at a discrete location in a propagation space, the propagation space comprising the three-dimensional space over which light waves or illumination forming the holographic intensity pattern propagates. The method comprises determining one or more data key-points of at least one potential object of interest (19) in the received holographic intensity data, and also comparing the determined one or more data key-points to at least one pre-determined propagation space invariant object descriptor associated with an object to determine a match in order to identify or detect the object and determine its location in the propagation space.

### BACKGROUND OF THE INVENTION

THIS INVENTION relates to a hologram processing method and system.

In holographic applications such as digital holographic microscopy (off-axis, in-line, etc.), holograms of objects of interest are generated by interference of reference and object waves from light sources at the surface of a recording means (e.g., CCD or CMOS recording means). Resulting holograms, particularly the holographic intensity patterns representing the holograms, of the objects are then used to reconstruct virtual images of the objects at the positions of the original objects. These reconstructed virtual images are then analysed in a conventional manner to investigate the objects, for example, properties of the objects.

Though the holographic intensity patterns typically comprise a large amount of information associated with the respective objects, this information is not often utilised or underutilised. It is therefore an object of the present invention at least to address this situation.

### SUMMARY OF THE INVENTION

According to a first aspect of the invention, there is provided a method comprising:
receiving holographic intensity data comprising at least a holographic intensity pattern or image at a discrete location in a propagation space, the propagation space comprising a space, for example, a three-dimensional space over which the illumination, associated with generating the holographic intensity pattern, propagates at least to facilitate generation of the holographic intensity data;
processing the received holographic intensity data to determine one or more data key-points of at least one potential object of interest in the received holographic intensity data; and
comparing the determined one or more data key-points to at least one pre-determined object descriptor associated with an object to determine a match, wherein the object descriptor is propagation space invariant.

The method may comprise providing a plurality of object descriptors, each object descriptor may comprise a plurality of descriptor subsets associated with a plurality of desired discrete locations in the propagation space respectively, wherein each descriptor subset may comprise one or more descriptor key-points.

Differently defined, it will be appreciated that the key-points may be collected over the propagation space and are therefore localized to the propagation space. The collection of key-points may form an object descriptor for the object of interest. It follows that the object descriptor may become propagation space invariant to allow detection and/or identification of an object of interest in a propagation space invariant manner, while the subset of key-points that lead to detection may additionally allow the localization of the object of interest in the propagation space.

The method may comprise facilitating one or both of identification of the potential object of interest and determination of the location of the identified object with respect to the propagation space on a match between determined data key-points of a potential object of interest and descriptor key-points of an object descriptor.

The method may comprise determining the data key-points by analysing the intensity valves of pixels associated with the received holographic intensity pattern.

The method may comprise:
receiving an image of the object;
applying a waveform propagation algorithm to the received image for a plurality of discrete locations across the propagation space thereby to generate a plurality of holographic intensity patterns corresponding to the discrete locations across the propagation space;
determining descriptor key-points for each generated holographic intensity pattern across the propagation space; and
using the determined descriptor key-points and information indicative of the associated discrete locations across the propagation space to generate the object descriptor associated with the object.

It will be noted that the plurality of generated holographic intensity patterns may be artificially generated by the waveform propagation equation. Though the method comprises automatically generating artificial holograms to train on, it will be appreciated that in some example embodiments, the method may comprise determining descriptor key-points for object descriptor determination by generating a plurality of physical holograms manually to train on.

The image of the object typically comprises a microscope image of the object.

The method may further comprise:
generating object descriptor subsets by associating the determined descriptor key-points and the corresponding discrete location in the propagation space;
generating the object descriptor associated with the object by associating each generated descriptor subset corresponding to the object; and
storing the generated object descriptor in the database.

In one example embodiment, the object descriptor is additionally scale space invariant, the method may therefore comprise:
generating a scale space for each of the plurality of holographic intensity patterns generated across the propagation space by applying a blurring algorithm to each of the generated holographic intensity patterns thereby generating blurred images;
determining differences between the generated blurred images by subtracting the same from each other;
locating extremal scale invariant key-points in the determined differences; and
using the scale invariant key-points to generate the scale space invariant object descriptor.

It will be noted that the method may comprise determining the accuracy of the match by:
applying a reconstruction algorithm to the received holographic intensity data to reconstruct the received holographic intensity data back to the discrete location in the propagation space associated with matching key-points;
deriving key-points at this location in the propagation space;
comparing the newly derived key-points to the object descriptor to determine confidence in a match.

In one example embodiment, the method may comprise the step of capturing the holographic intensity data.

According to a second aspect of the invention there is provided a system for processing holographic intensity data, the system comprising:
a database storing data;
a data receiver module configured to receive holographic intensity data comprising at least a holographic intensity pattern or image at a discrete location in a propagation space, the propagation space comprising a three-dimensional space over which the illumination, associated with generating the holographic intensity pattern, propagates at least to facilitate generation of the holographic intensity data;
data key-point extraction module configured to determine one or more data key-points of at least one potential object of interest in the received holographic intensity data, and
a comparator module configured to compare the determined one or more data key-points to at least one pre-determined object descriptor, stored in the database, associated with an object to determine a match, wherein the object descriptor is propagation space invariant.

The database may store a plurality of object descriptors, each object descriptor may comprise a plurality of descriptor subsets associated with a plurality of desired discrete locations in the propagation space respectively, wherein each descriptor subset may comprise one or more descriptor key-points. Each descriptor subset may comprise information indicative of an associated discrete location in the propagation space.

The system may comprise a classifier module configured to perform one or both of identification of the potential object of interest and determination of the location of the identified object with respect to the propagation space on a match, determined by the comparator module, between determined data key-points of a potential object of interest and descriptor key-points of an object descriptor.

The key-point extraction module may be configured to determine the data key-points by analysing the intensity valves of pixels associated with the received holographic intensity pattern.

The system may comprise a descriptor determining module comprising:
a training data receiver module configured to receive an image of the object;
a waveform propagation module configured to apply a waveform propagation algorithm to the received image for a plurality of discrete locations across the propagation space thereby to generate a plurality of holographic intensity patterns corresponding to the discrete locations across the propagation space; and
a training key-point extraction module configured to determine descriptor key-points for each generated holographic intensity pattern across the propagation space;
wherein the descriptor determining module is configured to use the determined descriptor key-points and information indicative of the associated discrete locations across the propagation space to generate the object descriptor associated with the object.

The descriptor determining module may be configured to:
generate object descriptor subsets by associating the determined descriptor key-points and the corresponding discrete location in the propagation space;
generate the object descriptor associated with the object by associating each generated descriptor subset corresponding to the object; and
store the generated object descriptor in the database.

In one example embodiment, the descriptor determining module may be configured to:
generate a scale space for each of the plurality of holographic intensity patterns generated across the propagation space by applying a blurring algorithm to each of the generated holographic intensity patterns thereby generating blurred images;
determine differences between the generated blurred images by subtracting the same from each other;
locate extremal scale invariant key-points in the determined differences; and
use the scale invariant key-points to generate the scale space invariant object descriptor.

It will be understood that the object may vary in shape and other visual characteristics across the propagation space and it may vary in size. The present invention advantageously addresses specifically the variation across propagation space. For the object of microscopic scale, it will be understood that the variation over object properties over propagation space is usually greater than the variation in size.

The classifier module may be configured to determine the accuracy of the match by performing at least the steps of:
applying a reconstruction algorithm to the received holographic intensity data to reconstruct the received holographic intensity data back to the discrete location in the propagation space associated with matching key-points;
deriving key-points at this location in the propagation space;
comparing the derived key-points to the object descriptor to determine a match.

The system may also comprise a holographic intensity data capturing means.

The holographic intensity data capturing means may comprise:
an illumination means configured to generate illumination;
a spatial filter located at a predetermined distance from the illumination means, the spatial filter comprising at least one illumination aperture for passage of illumination from the illumination means therethrough;
a sample holder removably locatable at a predetermined distance from the spatial filter, the sample holder being configured to hold a sample of material in the propagation space of the illumination from the illumination aperture; and
an image recording means located at a predetermined distance from the sample holder in the propagation space of the illumination from the sample holder, the image recording means being configured to generate at least a digital holographic intensity pattern of the material in the sample holder.

According to a third aspect of the invention, there is provided a non-transitory computer readable medium comprising a set of computer readable instructions which when executed on a computing device causes the same to perform the method steps as hereinbefore described.

### BRIEF DESCRIPTION OF THE DRAWINGS

FIG. 1 shows a schematic block diagram of a system for processing holographic intensity data in accordance with an example embodiment of the invention;

FIG. 2 shows a holographic intensity data capture means in accordance with an example embodiment of the invention;

FIG. 3 (a) shows an example original image of a sample comprising a plurality of objects;
(b) shows an image of a generated holographic intensity pattern;
(c) shows a reconstructed image of the holographic intensity pattern of (b);

FIG. 4 shows an illustration of a histogram in accordance with an example embodiment;

FIG. 5 shows an illustration of a disk illustrating vector locations in accordance with an example embodiment;

FIG. 6 shows a high level flow diagram of a method of processing holographic intensity data in accordance with an example embodiment;

FIG. 7 shows another flow diagram of a method in accordance with an example embodiment;

FIG. 8 shows yet another flow diagram of a method in accordance with an example embodiment; and

FIG. 9 shows a diagrammatic representation of a machine in the example form of a computer system in which a set of instructions for causing the machine to perform any one or more of the methodologies discussed herein, may be executed.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

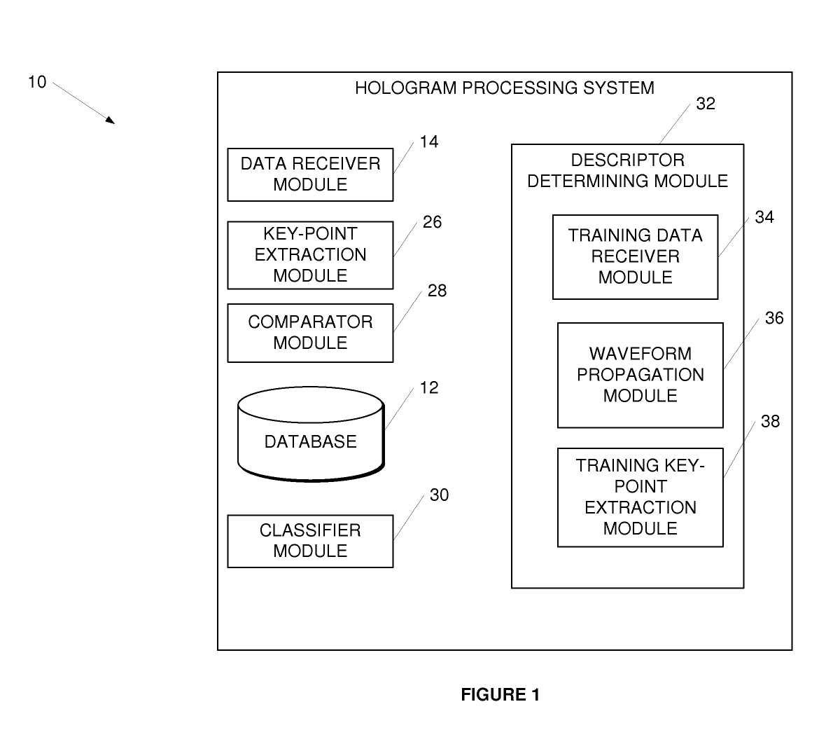

Referring to FIG. 1 of the drawings where a system in accordance with an example embodiment of the invention is generally indicated by reference numeral 10. The system 10 is typically a processing system 10 for processing holographic intensity data for various applications, for example, for purposes of identifying objects of interest in digital holographic microscopy.

The system 10 comprises a database or memory device 12 storing non-transitory data. The database 12 may be one or more suitable devices located at one or more locations but in data communication with each other to provide a means for storage of information digitally.

It will be noted that the system 10 may be a computer implemented or operated system and may comprise one or more processors having non-transitory computer readable medium/s, for example, the database 12 storing instructions or software which directs operation of the system 10 as herein described. Steps described with reference to method disclosed herein are typically achieved by application of one or more processing steps associated with the description as described herein.

Differently defined, the system 10 comprises a plurality of components or modules which correspond to the functional tasks to be performed by the system 10. The term “module” in the context of the specification will be understood to include an identifiable portion of code, computational or executable instructions, data, or computational object to achieve a particular function, operation, processing, or procedure. It follows that a module need not be implemented in software; a module may be implemented in software, hardware, or a combination of software and hardware. Further, the modules need not necessarily be consolidated into one device but may be spread across a plurality of devices. Some modules described may overlap in terms of function and in practice may comprise single modules. However, for ease of explanation, they will be described and referred to separately as the case may be.

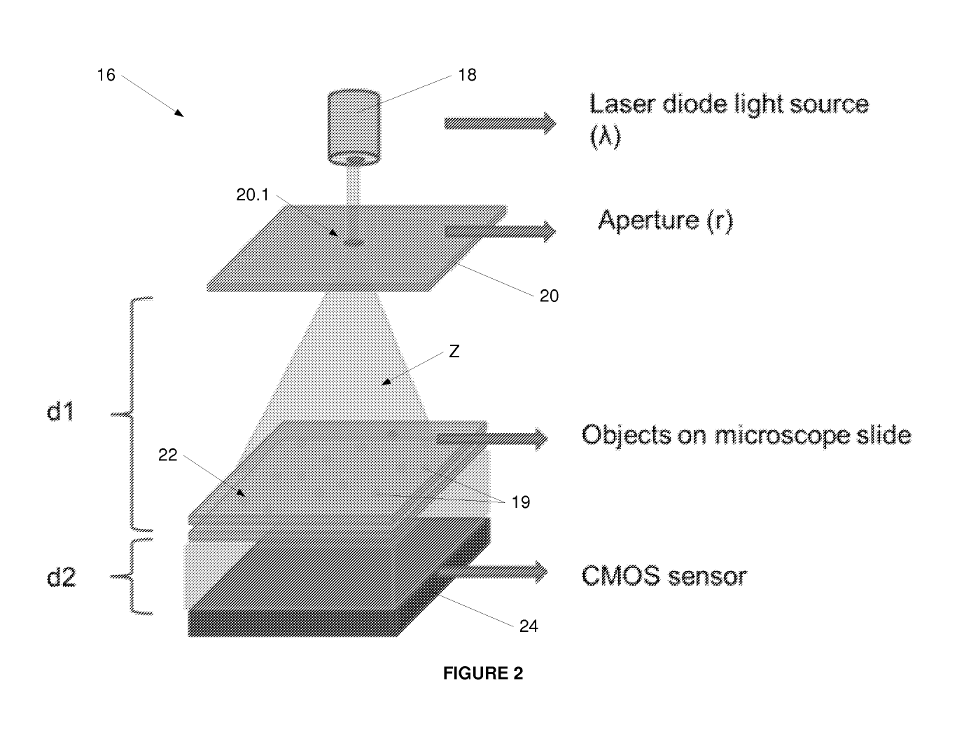

Referring now also to FIGS. 2 and 3, the system 10 comprises a data receiver module 14 configured to receive holographic intensity data comprising at least a holographic intensity pattern or image, an example of which is illustrated in FIG. 3(b). For brevity, in the description, the terms “hologram”, “holographic intensity pattern” and “holographic image” will be understood to refer to the same.

In one example embodiment, the data receiver module 14 may be configured to receive the holographic intensity data from a holographic intensity data capturing means 16 illustrated in FIG. 2, the means 16 being configured to capture the holographic intensity data. It follows that the module 14 is in data communication, either hardwired or wireless via a wireless communication channel, with the data capturing means 16. The holographic intensity pattern is typically associated with a material of interest comprising a plurality of objects of interest 19, for example, blood cells, therein. It will be understood that in some example embodiments, the system 10 may optionally comprise the data capturing means 16, the system 10 thereby comprising an in-line (or off-axis as the case may be) digital holographic microscope system.

In FIG. 2, the data capturing means 16 comprises an illumination means or source 18 configured to generate illumination. The illumination means 18 comprises a diode light source, for example, an infrared laser diode (808 nm) or a blue laser diode (408 nm). A planar spatial filter 20 is located at a predetermined distance from the illumination means, the spatial filter 20 comprising at least one circular illumination aperture 20.1 of approximately 50 μm diameter for passage of illumination from the illumination means 18 therethrough. The shape and/or dimension of the illumination aperture 20.1 is selected advantageously to improve the collimation of the light or illumination from the illumination means 18. In other words, it will be noted that the function of the aperture 20.1 is to create a collimated beam before the waves interact with the object.

The filter 20 is disposed transverse to a direction of propagation of illumination from the illumination means 18. Illumination emitted from the aperture 20.1 typically comprises diffracted light waves which propagate over a propagation space Z. The propagation space Z may be the defined loosely as the space over which light from the means 18 or diffracted light from the filter 20 propagates to facilitate generating the hologram. The propagation space Z may be a three-dimensional physical space. However, for the present description, the propagation space Z may correspond to single dimension parallel to the main axis of propagation of illumination or light waves from the illumination means 18 and this could be parameterised by Z.

The propagation space may be uniquely associated with a particular system 10 or means 16.

In any event, the means 16 also comprises a sample holder 22 removably locatable at a predetermined distance from the spatial filter 20, the sample holder 22 being configured to hold a sample of material in the propagation space Z of the illumination from the illumination aperture 20.1. The material in the slide typically comprises objects of interest 19, for example, blood cells. The sample holder 22 may comprise a transparent microscope slide, constructed of glass.

The means 16 lastly comprises an image recording means or image sensor 24 located at a predetermined distance from the sample holder 22 in the propagation space Z of the illumination from the sample holder 22. The image recording means 24 is typically configured to generate at least the digital holographic intensity pattern of the material in the sample holder 22 in response to the illumination incident thereon from the means 18 across the propagation space Z. It follows that the means 24 may be selected from a charge coupled device (CCD) or preferably a complementary metal oxide semiconductor (CMOS) image sensor which is disposed substantially transverse to the illumination propagation space Z.

Differently defined, the propagation space Z is the space over which illumination or light waves propagate from the means 18 or diffracted light from the filter 20 through the sample in the sample holder 18, to reach the means 24 to form the hologram of the sample in the sample holder 18.

The means 16 is typically lens-less and the digital holographic intensity pattern generated by the CMOS image sensor may comprise a matrix of pixels having pixel values corresponding to parameters such as pixel intensity, etc. associated with the holographic intensity data. In some example embodiments, the pixel values may be calculated from the values of one or more adjacent pixels for the purpose of image enhancement. It will be noted that to better estimate a pixel value, one could use information from adjacent pixels. Further accuracy could be achieved with super-resolution techniques, which in this case could be based on varying (independently or together) phase, wavelength, and relative spatial displacements between illumination means 18 and sensor or image recording means 24.

In any event, returning to FIG. 1, it will be noted that the holographic intensity pattern received by the module 14 corresponds substantially to a single discrete location in the propagation space Z.

The system 10 also comprises a data key-point extraction module 26 configured to process the received holographic intensity pattern and determine one or more data key-points of at least one potential object of interest in the received holographic intensity image. In one example embodiment, the module 26 traverses the pixels of the received holographic intensity image and selects pixels with intensity values of interest, for example, location of local maxima and minima positions, etc, in a conventional manner. It will be noted that the data key-points determined correspond to one or more pixels of interest as selected by the module 26. In some example embodiments, extremal points may also extracted from the difference of two adjacent snapshots through scale space. This may reduce the number of keypoints detected to more salient ones.

The system 10 also comprises a comparator module 28 configured to compare the determined one or more data key-points to a plurality of pre-determined object descriptors stored in the database 12 to determine a match. Each object descriptor is associated with a particular object, for example, a blood cell such as a white blood cell. In addition, and more importantly, it will be noted that the object descriptors are advantageously propagation space Z invariant. To this end, each object descriptor corresponding to an object typically comprises a plurality of descriptor subsets, wherein each descriptor subset comprises at least a descriptor key-point and information indicative of an associated discrete location in the propagation space Z.

The descriptor key-points may be similar to the data key-points in term of composition and may therefore also comprise data associated with pixels of interest, for example pixel intensity values. The comparator module 28 may therefore be configured at least to compare determined data key-points of a potential object of interest and descriptor key-points of the object descriptor to determine a match or substantial match. It will be appreciated that the comparator module 28 typically compares determined data key-points with descriptor key-points of all object descriptors stored in the database 12 in order to determine a substantial match.

Though the system 10 essentially processes pixels, or information associated therewith, associated with the received hologram, for ease of explanation, reference will be made to the key-points and areas of interest which in turn comprise one or more pixels of interest, or information associated therewith.

In one example embodiment, each descriptor key-point comprises a vector storing, for example, pixel intensity values associated with the descriptor key-points at that particular discrete location or point across the propagation space Z. It follows that the descriptor subset may comprise the vector associated with the key-point but additionally includes information indicative of the discrete location in the propagation space Z associated with the respective key-point. Differently defined, it will be understood that the propagation space invariant object descriptor will contain descriptor subsets of descriptor key-points, where each descriptor subset is derived from a discrete location in propagation space. If there is a match in the database 12 to a particular descriptor subset then this descriptor subset will indicate the location in propagation space. Thus in the object descriptor, or object descriptor vector, the subsets could even be ordered such that descriptor subsets amongst the first elements in the vector could correspond to one end of propagation space and those at the end of the vector to the other end of the propagation space (depending on the dimensions of the desired propagation space).

However, depending on various factors such as computational resources and efficiency, it will be appreciated that each key-point need not comprise a vector but may comprise a single pixel value, or average value, etc.

In any event, it will be appreciated that the training of an object descriptor to have a plurality of descriptor subsets for various discrete locations in the propagation space Z advantageously causes the resulting object descriptor to be advantageously invariant with respect to the propagation space Z. The training is usually performed with the same or similar means 16 which subsequently performs identification and/or detection.

The system 10 typically comprises a classifier module 30 configured to identify the potential object 19 of interest in the received holographic intensity pattern on a match, determined by the comparator module 28.

As a corollary, the classifier module 30 is also configured to determine the discrete location of the identified object with respect to the propagation space Z on a match by the module 28 as the descriptor key-points in the descriptor subsets are associated with the respective discrete locations in the propagation space Z. The latter may be done within the resolution permitted by the discretisation of the propagation space Z. In practical applications this means that the object could be identified from a single snapshot of the hologram (holographic intensity data) without having to refocus and search through holographic reconstructions to first find the object, thereby improving the speed of detection.

Determining the object descriptors may be done prior to operating the system 10 for identification of objects of interest.

In this regard, the system 10 comprises a descriptor determining module 32 configured to generate the object descriptors for use by the system 10 in a manner as hereinbefore described. It will be understood that the object descriptors need not be generated by the system 10 and may be generated externally and merely used by the system 10.

In particular, the module 32 further comprises a training data receiver module 34 configured to receive an image of the object. In this case, the image received by the module 34 is a conventional microscope image, for example, the image as illustrated in FIG. 3(a) and not a hologram. In some example embodiments, the module 34 receives a hologram which may be reconstructed for use in a similar manner as the conventional images.

The module 32 further comprises a waveform propagation module 36 configured to apply a waveform propagation algorithm to the image received by the module 34 to generate a plurality of holographic intensity patterns corresponding to different discrete locations across the propagation space Z. In particular, the module 36 is configured to discretise the propagation space Z, and for each desired discrete location across the discretised propagation space Z, apply the waveform propagation algorithm thereby to generate a hologram at that discrete location in the propagation space Z.

The module 36 may be configured to discretise the propagation space into a predetermined number of locations or zones for the purposed hereinbefore described, for example, depending on criteria such as computational efficiency, resolutions and accuracy considerations. To this end, it will be appreciated that the module 32 advantageously is configured to receive information indicative of at least the dimensions of the propagation space Z.

In a preferred example embodiment, the waveform propagation algorithm typically carries out or applies a method as described by the following waveform propagation equation (1):

$$\begin{matrix}I ( {α}^{′} , {β}^{′} ) = \frac{j}{λ} {\int }_{- ∞}^{∞} {\int }_{- ∞}^{∞} h ( x , y ) {E}_{R} ( x , y ) \frac{{e}^{( - j kr )}}{r} d x d y & ( Equation 1 ) \\ {r}^{′} = \sqrt{{( x - {α}^{′} )}^{2} + {( y - {β}^{′} )}^{2} + {z}^{2}} & ( Equation 2 ) \\ k = \frac{2 π}{λ} & ( Equation 3 )\end{matrix}$$

In the forward direction, when used for hologram generation, equation 1 gives I(α′, β′) which is the complex diffraction pattern formed at the imaging/sensor plane.
   This complex diffraction pattern is then combined with the reference wave to give the Holographic intensity pattern.
   h(x, y) is then treated as the image of the object of interest
   E_{R}(x, y) is the reference wave
   r′ is the straight line distance from a point in the plane of the object to a point in the plane of the complex diffraction pattern which is used to form the hologram.
   λ is the source wavelength.
   z is the axis of propagation
   (x, y) is now the plane in which the object lies
   (α′/β′) is the plane in which the diffraction pattern, which is used to form the hologram, lies.
In the reverse direction, when used for object reconstruction, equation 1 gives I(α′,β′) which is the reconstruction of the object of interest at the location where the original object was.
   h(x, y) is then treated as the holographic intensity pattern
   E_{R}(x, y) is the reference wave
   r′ is the straight line distance from a point in the plane of the hologram to a point in the plane of the object of interest.
   λ is the source wavelength.
   z is the axis of propagation
   (x, y) is now the plane in which the hologram lies
   (α′/β′) is the plane in which the object of interest lies.

The equation (1) is used by the module 36 to generate a holographic intensity patterns or snapshots corresponding to particular discrete locations across the propagation space Z with the image received by the module 34 as an input.

The propagation space Z in the context of determining the object descriptors will be understood to be substantially similar to the description furnished above with respect to identifying objects. In other words, the same hardware setup used in determining the object descriptors may ideally be substantially similar to the hardware setup used in identifying the objects, in this way, the dimensions of the propagation space Z is known by the system 10.

Regarding the selection of equation (1) for use by the module 36, it will be appreciated that the waveform propagation equation (1), in a sense, functions as a lens. It brings objects into focus. When the objects are in focus (as in a typical lens) the light waves are made to coincide at the point of focus while at other points they exist in various degrees of separation from each other. This is possible because the embedded phase information allows depth reconstruction which means that objects at different distances can be separated.

Another important point is that equation (1) describes the relationship of all the light waves at any point in the three-dimensional propagation space. If a sample of the propagating light is captured at some point in three-dimensional space, then equation (1) would allow the reconstruction of the point at another location.

In other words, the waveform propagation equation (1) firstly maintains the relationship of light waves through the propagation space Z and secondly functions as a lens (or transform on the light waves) and separates out the light waves from each other (or focuses them), these two operations are combined (and exploited) to create variations in propagation space Z.

The module 32 further comprises a training key-point extraction module 38 configured to determine descriptor key-points of interest or stable descriptor key-points for each generated holographic intensity pattern across the propagation space Z. This may be done in a manner as described above with reference to module 26. Instead, or in addition, a variety of saliency detectors may be applied over the propagation space Z. Salient points that occur across the propagation space Z are identified as points that are invariant across the propagation space Z. This particular subset will contribute to the detection or identification process only but in a stable manner.

The module 32 is then configured to use the determined descriptor key-points and information indicative of the associated discrete locations across the propagation space to generate the object descriptor associated with the object, for example, object 19. This may be done by generating the descriptor subsets by associating the descriptor key-points, identified by vectors, with the respective or corresponding discrete locations in the propagation space Z in a manner as described above for each snapshot generated by the wave propagation module 36. Once a plurality of descriptor subsets are generated for a particular object across the propagation space Z, the module 32 associates and stores the same in the database 12 as the object descriptor, for use by the system 10 to identify objects irrespective of their location in the propagation space Z.

In practical applications the invention allows for an object to be advantageously identified from a single snapshot of the hologram without having to refocus and search through the holographic reconstructions to first find the object, thereby improving the speed of detection which is advantageous in applications where processing resources is important.

In some example embodiments not described further, the system 10 may use the above principles and implement a statistical machine configured to apply a learning algorithm, for example a neural network, which could be trained to derive features automatically and to further use these to generate object descriptors (automatically) for identification without the more discrete derivation of features or set of descriptors. The system 10 may be configured to generate holograms for training the statistical machine.

In a preferred example embodiment, in addition to being propagation space Z invariant, the object descriptors can be made to be scale space invariant thereby to identify an object of interest across the propagation space as well as scale space S.

Having an object descriptor which is both propagation space Z and scale space S invariant is advantageous because, firstly, in the Fresnel region, the diffraction pattern of a small object increases in size as the distance z between the imaging plane and the object of interest increases. This causes the holographic information for a particular object of interest to spread out over the imaging plane. Tracking the spatial changes of features over the propagation space will account for this variation. Secondly, objects may occur at different sizes due to magnification used; the training sample and the sample under observation may be of different sizes and incorporating scale space invariance accounts for this variation. It may also be noted that at microscopic levels, variance over the propagation space may be larger than the variance over scale space and in this regard, the scale space aspect of the present invention is merely as described as an additional feature of the invention.

The descriptor determining module 32 is therefore generally configured to find extremal key-points (for an object of interest) over the scale space S of each snapshot generated by the module 36 across the propagation space and to use these descriptor key-points to construct a rotationally invariant object descriptor. In other words, the module 32 generates a set of unique descriptor key-points which would enable identification of an object of interest at any relevant scale over the propagation space. In this regard, it will be noted that the holographic pattern of the object changes over the propagation space.

In any event, the descriptor determining module 32 may be configured to generate a scale space for each of the plurality of holographic intensity patterns generated across the propagation space Z by applying a blurring algorithm to each of the generated holographic intensity patterns thereby generating blurred images. The blurring algorithm may comprise convolving each generated snapshot with a series of Gaussian functions each with a different variance (which approximates scale). The original image is then down-sampled and again convolved with the series of Gaussian functions.

The module 32 is then configured to determine differences between the generated blurred images by subtracting the same from each other, in other words determining the differences in Gaussians (DoG) over the scale space. The module 32 is then configured to locate extremal scale invariant key-points in the DoG, for example, in a similar manner as touched on above for locating key-points of interest across varying scales. It will be understood that key-points that are part of line segments and which have low contract are eliminated accordingly.

The module 32 is then configured to use the located scale invariant key-points to generate the scale space invariant object descriptor for each discrete location in the scale space.

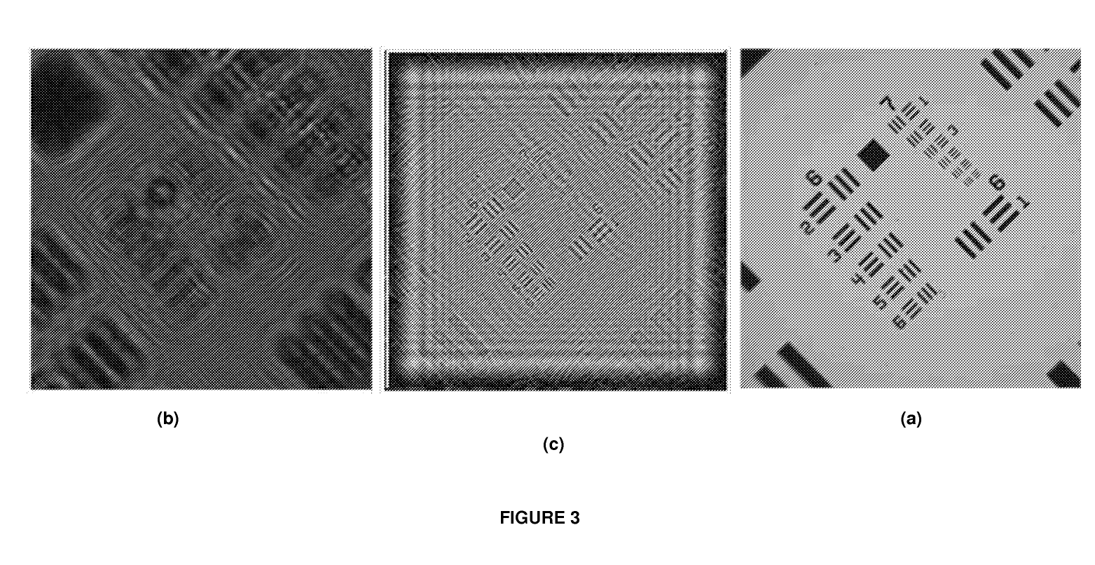

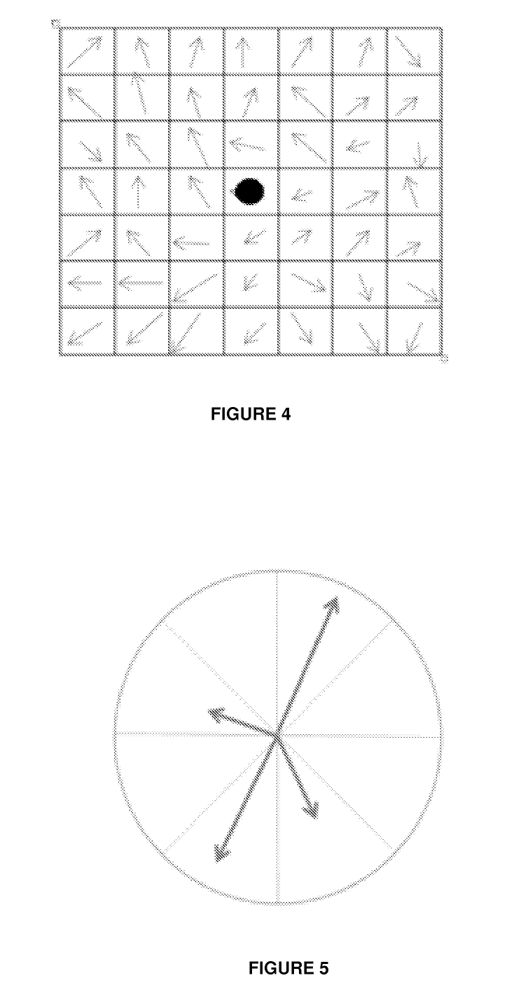

Referring now to FIGS. 4 and 5, it will be noted that in creating the orientation invariant object descriptor, the module 32 is configured to determine a pixel neighbourhood of interest around a located key-point, for example, the 7×7 neighbourhood. The module 32 then determines the gradient at each pixel in the neighbourhood by applying the following equations:

m(x,y)={square root over ((L(x+1,y)−L(x−1,y))²+(L(x,y+1)−L(x,y−1))²)}

θ(x,y)=tan⁻¹((L(x,y+1)−L(x,y−1))/(L(x+1,y)−L(x−1,y)))

m(x, y) is the magnitude of the gradient in a local neighbourhood of the keypoint within the image L(x, y). θ(x, y) is the orientation of the gradient in the local neighbourhood.

The illustrated histogram in FIG. 4 of orientations is then typically generated by the module 32 for a neighbourhood around the located key-point. A disk as illustrated in FIG. 5 is then discretised and all gradients which fall into the same orientation for a sector are added together (magnitudes) and assigned to the direction of that sector.

The module 32 is then operable to create a vector of 6 elements. The smaller angular difference between the largest sector and the smallest sector is determined and an estimate in sector distance is determined by the module 32. The module 32 then assigns the difference (in approximate sectors) to the first element in a 6 element vector.

The module 32 then takes the sector difference between the largest sector orientation and the next smallest and assigns the sector difference to the next element in the vector and so on for all the vectors. If there are no more vectors, the remaining elements are assigned zero. For example, in from FIG. 5, this would give a vector [3,4,5,0,0,0] for the located key-point. The module 32 performs the same for all key-points in each snapshot generated. This creates rotation invariance. Each key-point is now identified by the 6 element vector.

Each key-point located will have an associated vector which when associated with information indicative of the discrete location in propagation space forms a discrete subset as hereinbefore described. The vector as described accounts for variations in scale space but it will be noted that it will be in the propagation space invariant descriptor as an optional parameter and as an adjunct the invention described herein.

All the key-points, particularly the descriptor subsets, may be used to generate the object descriptor for an object which is advantageously both scale and propagation space invariant.

It will be noted that the classifier module 30 may be configured to determine the accuracy of the match by reconstructing the holographic intensity pattern received by the module 14 back to a determined point in the propagation space (as determined by a match with an object descriptor) and deriving key-points at this location. An example of a reconstructed image is illustrated in FIG. 3 (c). These derived key-points could be matched again to the database 12. A correspondence with the same object of interest reinforces the identification by the system 10. It will be appreciated that the essential concept that these steps exploit is that by finding more key-points consistent with that object of interest (determined from the first detection) confidence in detection/identification or accuracy thereof is improved.

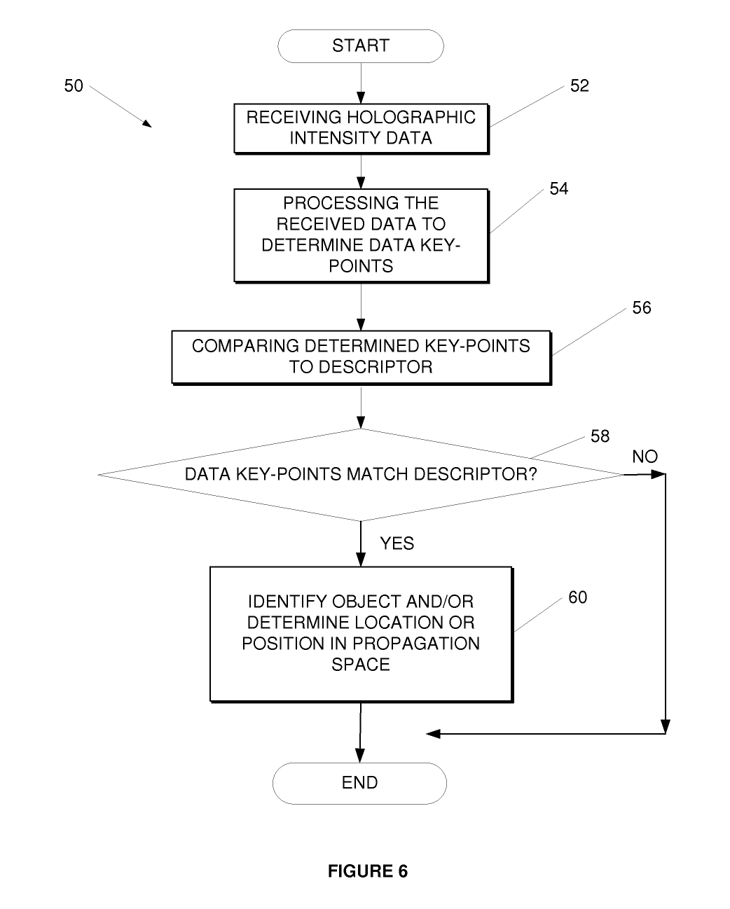

Example embodiments will now be further described in use with reference to FIGS. 6 to 8. The example methods shown in FIGS. 6 to 8 are described with reference to FIGS. 1 to 5, although it is to be appreciated that the example methods may be applicable to other systems (not illustrated) as well.

In FIG. 6, a high level flow diagram of a method in accordance with an example embodiment of the invention is generally indicated by reference numeral 50.

The method 50 is typically carried out by a processor or system, for example, system 10 for processing holograms by the respective modules hereinbefore described. In this regard, the method 50 may be a method of processing holograms to identifying one or more objects of interest therein. For ease of description, the method 50 will be described with reference to an application to identify a white blood cell in a hologram of a blood sample.

The method 50 typically comprises receiving, at block 52, holographic intensity data comprising at least a holographic intensity pattern or image of a blood sample at a discrete location in the propagation space Z. The image is typically a digital holographic image received electronically by the data receiver module 14 from a CMOS image capturing device or sensor 24.

The method 50 may comprise processing, at block 54, the received holographic intensity data to determine data key-points of a potential object of interest, i.e., a white blood cell in the received holographic intensity image. In some example embodiments, the determination of the data key-points may entail the extraction of extremal points from a difference of Gaussians and the generation of a vector for each determined data key-point of interest by the module 26, for example, in a similar manner as hereinbefore described with reference to FIGS. 4 and 5.

The method 50 then comprises comparing, at block 56 & 58, for example, by way of the module 28, the determined data key-points to at least one pre-determined object descriptor stored in the database 12. The method 50 comprises comparing each determined data key-point, particularly information associated therewith, with descriptor key-points as described above in order to determine a match wherein the descriptor are propagation space invariant and optionally scale space invariant.

If the comparison step 56/58 results in a match, then the method 50 correspondingly identifies, at block 60 by way of the module 30 as described above, that the object associated with the determined data key-points is a white blood cell as the matching descriptor key-point of the object descriptor is typically associated with the object which in this case is a white blood cell.

The method 50 may be repeated for each data key-point of interest in the received holographic image.

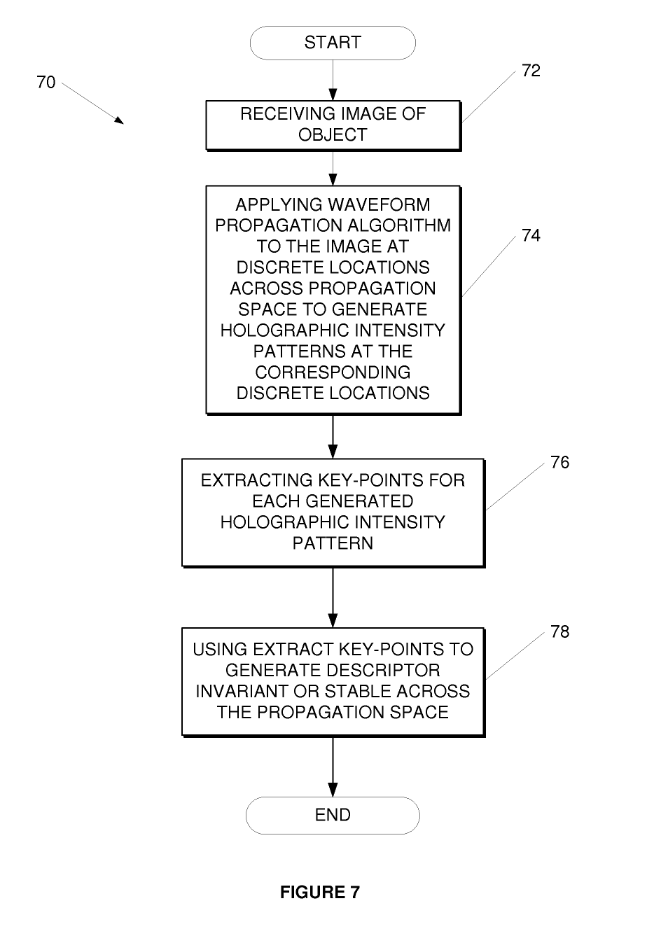

In FIG. 7, another flow diagram of a method in accordance with an example embodiment is generally indicated by reference numeral 70. The method 70 is typically a method employed to generate or create the object descriptors for particular objects. The method 70 may therefore be repeated for every object of interest which is desired to be identified, for example, white blood cells, red blood cells, or the like. The method 70 is typically carried out by the object descriptor determining module 32.

The method 70 comprises receiving, at block 72 by way of module 34, an image of the object of interest for which an object descriptor is desired to be generated. As mentioned above, the image received is typically a microscope image of the object, for example, an optical microscope image of a white blood cell.

The method 70 comprises applying, at block 74, a waveform propagation algorithm to the received image for a plurality of discrete locations across the propagation space Z thereby to generate a plurality of holographic intensity patterns, snapshots or images corresponding to the discrete locations across the propagation space. It follows that the method 70 may comprise a prior step of receiving, unless a prior, information indicative of the dimensions of the propagation space Z as well as discretising the propagation space Z.

The method 70 then comprises determining, at block 76, descriptor key-points for each generated holographic intensity pattern across the propagation space Z. In other words, the method 70 traverses each of the holograms generated across the propagation space Z to extract stable descriptor-key points.

The method 70 then comprises using, at block 78, the determined descriptor key-points and information indicative of the associated discrete locations across the propagation space Z to generate the object descriptor associated with the object. In this way, the object descriptor is at least propagation space Z invariant.

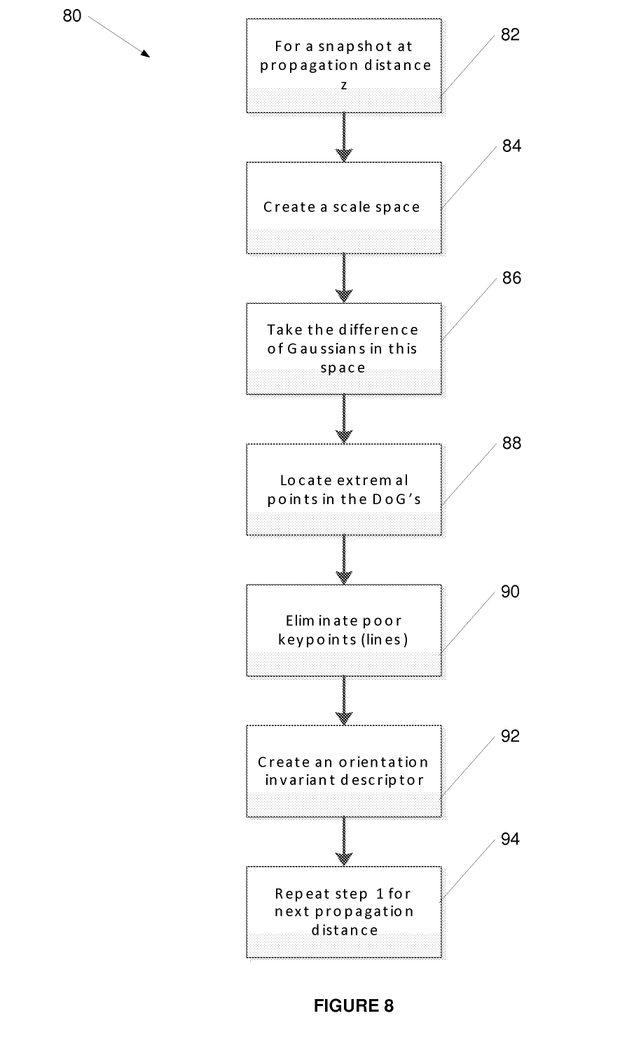

In FIG. 8, another flow diagram of a method in accordance with an example embodiment of the invention is generally indicated by reference numeral 80. As described above, in a preferred example embodiment of the invention, the object descriptors are both propagation space Z and scale space S invariant. The method of FIG. 8 provides at least some of the steps in realising the desired object identifier and it will be noted that FIG. 8 describes but one conventional manner in which to generate scale space invariance. As mentioned herein, the scale space invariance of the object descriptors in the present invention are optional.

In particular, the method 80 comprises firstly the step which is not illustrated of discretising the propagation space.

The method 80 then applies the waveform propagation algorithm embodying the waveform propagation equation (1) as described above to an image of the object of interest to project a series of holographic data snapshots where each snapshot corresponds to a location in propagation space Z. The image is similar, if not identical, to the image described with reference to FIG. 7.

The method 80 then comprises determining, at block 82, that for each snapshot (holographic image) create, at block 84, a scale space. As described briefly above, this is done by blurring the image by convolving it with a series of Gaussian functions, each with a different variance (which approximates scale). The original image is down-sampled and again convolved with the series of Gaussian functions in a substantially conventional manner.

The method 80 comprises taking, at block 86, the difference of Gaussians (DoG) over the scale space and locating, at block 88, extremal key-points in the DoG's.

Key-points that are part of line segments and those of low contrast are excluded at block 90.

The method 80 then comprises creating, or generating, at block 92, an orientation invariant unique descriptor key-point for each key-point.

The method 80, at block 94, then comprises the step of repeating the method 80 for all holographic snapshots.

It will be noted that the method 80 may comprise operating the module 32 in a manner as described with reference to FIGS. 4 and 5 to generate the vector corresponding to the scale invariant key-points.

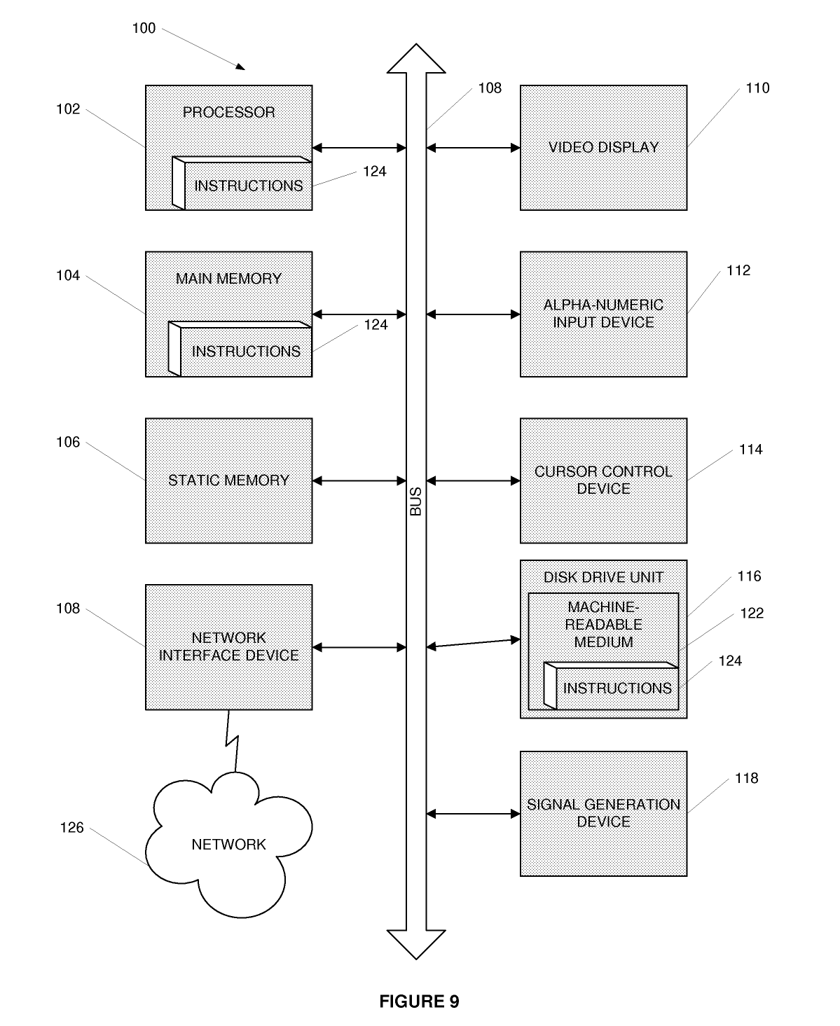

FIG. 9 shows a diagrammatic representation of machine in the example of a computer system 100 within which a set of instructions, for causing the machine to perform any one or more of the methodologies discussed herein, may be executed. In other example embodiments, the machine operates as a standalone device or may be connected (e.g., networked) to other machines. In a networked example embodiment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated for convenience, the term “machine” shall also be taken to include any collection of machines that individually or jointly execute a set (or multiple sets) of instructions to perform any one or more of the methodologies discussed herein.

In any event, the example computer system 100 includes a processor 102 (e.g., a central processing unit (CPU), a graphics processing unit (GPU) or both), a main memory 104 and a static memory 106, which communicate with each other via a bus 108. The computer system 100 may further include a video display unit 110 (e.g., a liquid crystal display (LCD) or a cathode ray tube (CRT)). The computer system 100 also includes an alphanumeric input device 112 (e.g., a keyboard), a user interface (UI) navigation device 114 (e.g., a mouse, or touchpad), a disk drive unit 116, a signal generation device 118 (e.g., a speaker) and a network interface device 120.

The disk drive unit 16 includes a machine-readable medium 122 storing one or more sets of instructions and data structures (e.g., software 124) embodying or utilised by any one or more of the methodologies or functions described herein. The software 124 may also reside, completely or at least partially, within the main memory 104 and/or within the processor 102 during execution thereof by the computer system 100, the main memory 104 and the processor 102 also constituting machine-readable media.

The software 124 may further be transmitted or received over a network 126 via the network interface device 120 utilising any one of a number of well-known transfer protocols (e.g., HTTP).

Although the machine-readable medium 122 is shown in an example embodiment to be a single medium, the term “machine-readable medium” may refer to a single medium or multiple media (e.g., a centralized or distributed database, and/or associated caches and servers) that store the one or more sets of instructions. The term “machine-readable medium” may also be taken to include any medium that is capable of storing, encoding or carrying a set of instructions for execution by the machine and that cause the machine to perform any one or more of the methodologies of the present invention, or that is capable of storing, encoding or carrying data structures utilised by or associated with such a set of instructions. The term “machine-readable medium” may accordingly be taken to include, but not be limited to, solid-state memories, optical and magnetic media, and carrier wave signals.

The invention as hereinbefore described conveniently provides a mean of identifying and/or detecting objects of interest across propagation space, and (optionally) scale space, which may advantageously find application in detecting and locating objects in a volume simply by using a single digitally, captured hologram. In some cases, this attempt to reduce computation tedium and inefficiencies associated with locating objects using holographic principles. The invention allows for a stable set of features to be extracted to be used for the classification of objects of interest. In order to do this, the invention concerned finds stable features across the entire transformation space, encompassing a much broader scope that existing techniques for obtaining hologram signatures, where only one point or a single snapshot along the axis of propagation is used. By using a broader space to extract hologram signatures, the invention provides a more robust identifier than just using a single snapshot, with a higher tolerance.

The feature extraction process of the invention is also advantageous for any type of depth measurement to be successfully achieved, as the process is independent of where the object lies along the axis of propagation. Thus, the objects of interest could lie at different depths or layers within a volume, but individual signatures could still be extracted for every object, regardless of its position within the volume. For analysis of samples with multi-layers, the invention thus provides an improved and more robust object classifier.

This invention also advantageously makes use of the large amount of information provided in a hologram to identify objects in the hologram in an electronic manner without the need for reconstruction of images and use of experts to identify objects of interest, etc.

1. A method for processing holographic intensity data, the method comprising:
receiving holographic intensity data comprising at least a holographic intensity pattern or image at a discrete location in a propagation space, wherein the propagation space comprises a space over which the illumination, associated with generating the holographic intensity pattern, propagates at least to facilitate generation of the holographic intensity data;
processing the received holographic intensity data to determine one or more data key-points of at least one potential object of interest in the received holographic intensity data, and
comparing the determined one or more data key-points to at least one predetermined object descriptor associated with an object to determine a match, wherein the object descriptor is propagation space invariant.

2-21. (canceled)

22. The method as claimed in claim 1, the method comprising providing a plurality of object descriptors, each object descriptor comprising a plurality of descriptor subsets associated with a plurality of desired discrete locations in the propagation space respectively, wherein each descriptor subset comprises one or more descriptor key-points.

23. The method as claimed in claim 22, the method comprising facilitating one or more of identification and detection of the potential object of interest and determination of the location of the identified object with respect to the propagation space on a match between one or more determined data key-points of a potential object of interest and descriptor key-points of an object descriptor.

24. The method as claimed in claim 1, the method comprising determining the data key-points by analysing the intensity values of pixels associated with the received holographic intensity pattern.

25. The method as claimed in claim 22, the method comprising:
receiving an image of the object;
applying a waveform propagation algorithm to the received image for a plurality of discrete locations across the propagation space thereby to generate a plurality of holographic intensity patterns corresponding to the discrete locations across the propagation space;
determining descriptor key-points for each generated holographic intensity pattern across the propagation space; and
using the determined descriptor key-points and information indicative of the associated discrete locations across the propagation space to generate the object descriptor associated with the object.

26. The method as claimed in claim 25, wherein the image of the object comprises a microscope image of the object.

27. The method as claimed in claim 25, the method comprising:
generating descriptor subsets by associating the determined descriptor key-points and the corresponding discrete location in the propagation space;
generating the object descriptor associated with the object by associating each generated descriptor subset corresponding to the object; and
storing the generated object descriptor in a database.

28. The method as claimed in claim 25, wherein the object descriptor is additionally scale space invariant across scale space.

29. The method as claimed in claim 28, the method comprising:
generating a scale space for each of the plurality of holographic intensity patterns generated across the propagation space by applying a blurring algorithm to each of the generated holographic intensity patterns thereby generating blurred images;
determining differences between the generated blurred images by subtracting the same from each other;
locating extremal scale invariant key-points in the determined differences; and
using the scale invariant key-points to generate the scale space invariant object descriptor.

30. The method as claimed in claim 1, the method comprising determining the accuracy of the match by:
applying a reconstruction algorithm to the received holographic intensity data to reconstruct the received holographic intensity data back to a discrete location in the propagation space associated with matching key-points;
deriving key-points at this location in the propagation space; and
comparing the newly derived key-points to the object descriptors in the database to increase the confidence in a match.

31. A system for processing holographic intensity data, the system comprising:
a database storing data;
a data receiver module configured to receive holographic intensity data comprising at least a holographic intensity pattern or image at a discrete location in a propagation space, the propagation space comprising a space over which the illumination, associated with generating the holographic intensity pattern, propagates at least to facilitate generation of the holographic intensity data;
a data key-point extraction module configured to process the received holographic intensity data to determine one or more data key-points of at least one potential object of interest in the received holographic intensity data, and
a comparator module configured to compare the determined one or more data key-points to at least one pre-determined object descriptor, stored in the database, associated with an object to determine a match, wherein the object descriptor is propagation space invariant.

32. The system as claimed in claim 31, wherein in the database storing a plurality of object descriptors, each object descriptor comprises a plurality of descriptor subsets associated with a plurality of desired discrete locations in the propagation space respectively, wherein each descriptor subset comprises one or more descriptor key-points.

33. The system as claimed in claim 32, wherein the system comprises a classifier module configured to perform one or more of identification and detection of the potential object of interest and determination of the location of the identified object with respect to the propagation space on a match, determined by the comparator module, between one or more determined data key-points of a potential object of interest and descriptor key-points of an object descriptor stored in the database.

34. The system as claimed in claim 31, wherein the data key-point extraction module is configured to determine the data key-points by analysing the intensity values of pixels associated with the received holographic intensity pattern.

35. The system as claimed in claim 32, wherein the system comprises a descriptor determining module comprising:
a training data receiver module configured to receive an image of the object;
a waveform propagation module configured to apply a waveform propagation algorithm to the received image for a plurality of discrete locations across the propagation space thereby to generate a plurality of holographic intensity patterns corresponding to the discrete locations across the propagation space; and
a training key-point extraction module configured to determine descriptor key-points for each generated holographic intensity pattern across the propagation space;
wherein the descriptor determining module is configured to use the determined descriptor key-points and information indicative of the associated discrete locations across the propagation space to generate the object descriptor associated with the object.

36. The system as claimed in claim 35, wherein the image of the object comprises a microscope image of the object.

37. The system as claimed in claim 35, wherein the descriptor determining module is configured to:
generate object descriptor subsets by associating the determined descriptor key-points and the corresponding discrete location in the propagation space;
generate the object descriptor associated with the object by associating each generated descriptor subset corresponding to the object; and
store the generated object descriptor in the database.

38. The system as claimed in claim 35, wherein the object descriptor is additionally scale space invariant, wherein the descriptor determining module is configured to:
generate a scale space for each of the plurality of holographic intensity patterns generated across the propagation space by applying a blurring algorithm to each of the generated holographic intensity patterns thereby generating blurred images;
determine differences between the generated blurred images by subtracting the same from each other;
locate extremal scale invariant key-points in the determined differences; and
use the scale invariant key-points to generate the scale space invariant object descriptor.

39. The system as claimed in claim 33, wherein the classifier module is configured to determine the accuracy of the match by performing at least the steps of:
applying a reconstruction algorithm to the received holographic intensity data to reconstruct the received holographic intensity data back to a discrete location in the propagation space associated with matching key-points;
deriving key-points at this location in the propagation space; and
comparing the derived key-points to the object descriptor to determine a match.

40. The system as claimed in claim 31, wherein the system comprises a holographic intensity data capturing means comprising:
an illumination means configured to generate illumination;
a spatial filter located at a predetermined distance from the illumination means, wherein the spatial filter comprises at least one illumination aperture for passage of illumination from the illumination means therethrough;
a sample holder removably locatable at a predetermined distance from the spatial filter, wherein the sample holder is configured to hold a sample of material in the propagation space of the illumination from the illumination aperture; and
an image recording means located at a predetermined distance from the sample holder in the propagation space of the illumination from the sample holder, wherein the image recording means is configured to generate at least a digital holographic intensity pattern of the material in the sample holder.

41. A non-transitory computer readable storage medium comprising a set of instructions, which when executed by a computing device causes the same to perform a method comprising:
receiving holographic intensity data comprising at least a holographic intensity pattern or image at a discrete location in a propagation space, wherein the propagation space comprising a space over which the illumination, associated with generating the holographic intensity pattern, propagates at least to facilitate generation of the holographic intensity data;
processing the received holographic intensity data to determine one or more data key-points of at least one potential object of interest in the received holographic intensity data, and
comparing the determined one or more data key-points to at least one predetermined object descriptor stored associated with an object to determine a match, wherein the object descriptor is propagation space invariant.
